(19) United States
(12) Patent Application Publication
(10) Pub. No.: US 2017/0235607 A1
(43) Pub. Date: Aug. 17, 2017

(54) METHOD FOR OPERATING SEMICONDUCTOR DEVICE AND SEMICONDUCTOR SYSTEM

(71) Applicant: SAMSUNG ELECTRONICS CO., LTD., Suwon-Si (KR)

(72) Inventors: JUNG-HI MIN, GOYANG-SI, GYEONGGI-DO (KR); KWANG-HYUN LA, UIWANG-SI, GYEONGGI-DO (KR)

(21) Appl. No.: 15/340,138

(22) Filed: Nov. 1, 2016

(30) Foreign Application Priority Data
Feb. 12, 2016 (KR) 10-2016-0016229

(51) Int. Cl. G06F 9/50; G06F 13/42; G06F 9/48

(52) U.S. Cl. CPC G06F 9/5011; G06F 9/4881; G06F 13/4221

(57) ABSTRACT

A method for operating a semiconductor device includes obtaining task structure information of a task processed in a multiprocessor system. The multiprocessor system includes a plurality of nodes, each comprising one or more processing units and a memory directly connected to the processing units. The plurality of nodes include a local node to which an input/output (I/O) device is directly connected and a remote node having no direct connection to the I/O device. The method further includes evaluating the task structure information to determine whether the task is an I/O intensive task and assigning the task to the local node if the task is evaluated to be the I/O intensive task.

This application claims priority from Korean Patent Application No. 10-2016-0016229 filed on Feb. 12, 2016 in the Korean Intellectual Property Office, the disclosure of which is incorporated herein by reference in its entirety.

### BACKGROUND

1. Field of the Disclosure

The present disclosure relates to a method for operating a semiconductor device and a semiconductor system.

2. Description of the Related Art

The architecture of a multiprocessor system may be implemented in a variety of ways. Among various architectures, the performance of the multiprocessor system having an architecture using a common resource such as a shared bus or a shared memory may degrade as the number of processors (or processing units) increases.

To overcome this, there is proposed an architecture in which processors are divided into clusters, and the clusters are connected to one another via interconnection. In such architecture, separate memories are provided in the multiprocessor system, each for respective clusters. Such separate memories are connected to one another via interconnection, i.e., they may be implemented as a so-called distributed memory system.

The distributed memory system may be implemented, for example, as a uniform memory access (UMA) architecture in which every processor has equal access time to memories, or as a non-uniform memory access (NUMA) architecture in which the memories are conceptually divided into a local memory and a remote memory such that the processors have different access time between the local memory and the remote memory.

### SUMMARY

Aspects of the present disclosure provide a method for operating a semiconductor device, especially in a multiprocessor system using a NUMA architecture, by which an I/O intensive task can be efficiently processed.

Aspects of the present disclosure also provide a computer-readable storage medium, especially in a multiprocessor system using a NUMA architecture, by which an I/O intensive task can be efficiently processed.

Aspects of the present disclosure also provide a semiconductor device, especially in a multiprocessor system using a NUMA architecture, capable of process an I/O intensive task efficiently.

Aspects of the present disclosure also provide a semiconductor system, especially in a multiprocessor system using a NUMA architecture, capable of process an I/O intensive task efficiently.

According to an aspect of the present disclosure, there is provided method for operating a semiconductor device includes obtaining task structure information of a task processed in a multiprocessor system. The multiprocessor system includes a plurality of nodes, each comprising one or more processing units and a memory directly connected to the processing units. The plurality of nodes include a local node to which an input/output (I/O) device is directly connected and a remote node having no direct connection to the I/O device. The method further includes evaluating the task structure information to determine whether the task is an I/O intensive task and assigning the task to the local node if the task is evaluated to be the I/O intensive task.

According to another aspect of the present disclosure, there is provided a method for operating a semiconductor device. The method includes obtaining a list of a plurality of tasks processed in a multiprocessor system, obtaining a list of a plurality of nodes included in the multiprocessor system, sorting the plurality of tasks into I/O intensive tasks and normal tasks, assigning the I/O intensive tasks to a local node to which an I/O device is directly connected, and assigning the normal tasks to a remote node having no direct connection to the I/O device.

According to still another aspect of the present disclosure, there is provided a non-transitory computer-readable storage medium having instructions, which when executed by a processor, cause the processor to perform a method. The method includes obtaining task structure information of a task processed in a multiprocessor system. The multiprocessor system includes a plurality of nodes, each having one or more processing units, and a memory directly connected to the processing units. The plurality of nodes including a local node to which an I/O device is directly connected and a remote node having no direct connection to the I/O device. The method further includes evaluating the task structure information to determine whether the task is an I/O intensive task and assigning the task to the local node if the task is evaluated to be the I/O intensive task.

According to still another aspect of the present disclosure, there is provided a semiconductor system. The semiconductor system includes a task evaluating unit configured to obtain task structure information, of a task processed in a multiprocessor system, and a list of a plurality of nodes included in the multiprocessor system. The task evaluating unit evaluates the task structure information to determine whether the task is an I/O intensive task. A node selecting unit searches the list of nodes to select a target node to which the task is assigned, between a local node to which an I/O device is directly connected and a remote node having no direct connection to the I/O device, based on the determination as to whether the task is an I/O intensive task. A task assigning unit assigns the task to the selected target node.

According to still another aspect of the present disclosure, there is provided a computing device having a memory, which stores computer-readable instructions, and an electronic controller that executes the computer-readable instructions, so as to perform a method of controlling the execution of tasks by a multiprocessor system. The multiprocessor system includes a plurality of nodes, each of the nodes having one or more electronic processors and a memory directly connected to the one or more processors. The nodes include a local node to which an input/output (I/O) device is directly connected and a remote node having no direct connection to an I/O device. The method includes evaluating information pertaining to a task to determine whether the task includes an expected amount of communication with the I/O device exceeding a predetermined amount and assigning the task preferentially to the local node if the amount of expected communication is evaluated to exceed the predetermined amount.

These and other aspects, embodiments and advantages of the present disclosure will become immediately apparent to those of ordinary skill in the art upon review of the Detailed Description and Claims to follow.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram schematically illustrating an operating environment for a semiconductor system according to an exemplary embodiment of the present disclosure;

FIG. 2 is a diagram schematically illustrating an environment in which a semiconductor system according to an exemplary embodiment of the present disclosure may be implemented;

FIG. 3 is a block diagram schematically illustrating the scheduler of FIG. 2 in greater detail, according to an exemplary embodiment of the present disclosure;

FIG. 4 is a flowchart for illustrating a method for operating a semiconductor device according to an exemplary embodiment of the present disclosure;

FIG. 5 is a diagram for schematically illustrating a method for operating a semiconductor device according to an exemplary embodiment of the present disclosure;

FIG. 6 is a flowchart for illustrating a method for operating a semiconductor device according to another exemplary embodiment of the present disclosure;

FIG. 7 is a diagram schematically illustrating a method for operating a semiconductor device according to another exemplary embodiment of the present disclosure;

FIG. 8 is a flowchart for illustrating a method for operating a semiconductor device according to yet another exemplary embodiment of the present disclosure;

FIG. 9 is a diagram schematically illustrating a method for operating a semiconductor device according to still another exemplary embodiment of the present disclosure;

FIG. 10 is a diagram schematically illustrating a method for operating a semiconductor device according to yet another exemplary embodiment of the present disclosure;

FIG. 11 is a flowchart for illustrating a method for operating a semiconductor device according to yet another exemplary embodiment of the present disclosure;

FIG. 12 is a diagram schematically illustrating a method for operating a semiconductor device according to still another exemplary embodiment of the present disclosure;

FIG. 13 is a block diagram of an electronic system that can employ the method for operating a semiconductor device and a semiconductor system according to the exemplary embodiments of the present disclosure; and

FIGS. 14 to 16 show examples of semiconductor systems that can employ the method of operating a semiconductor device according to some exemplary embodiments of the present disclosure.

### DETAILED DESCRIPTION OF THE EMBODIMENTS

Embodiments will be described in detail with reference to the accompanying drawings. The disclosure, however, may be embodied in various different forms, and should not be construed as being limited only to the illustrated embodiments. Rather, these embodiments are provided as examples so that this disclosure will be thorough and complete, and will fully convey the concept of the disclosure to those skilled in the art. Accordingly, known processes, elements, and techniques are not described with respect to some of the embodiments of the disclosure. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the disclosure.

Spatially relative terms, such as “beneath”, “below”, “lower”, “under”, “above”, “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Advantages and features of the present disclosure and methods of accomplishing the same may be understood more readily by reference to the following detailed description of preferred embodiments and the accompanying drawings.

Hereinafter, preferred embodiments of the present disclosure will be described with reference to the accompanying drawings.

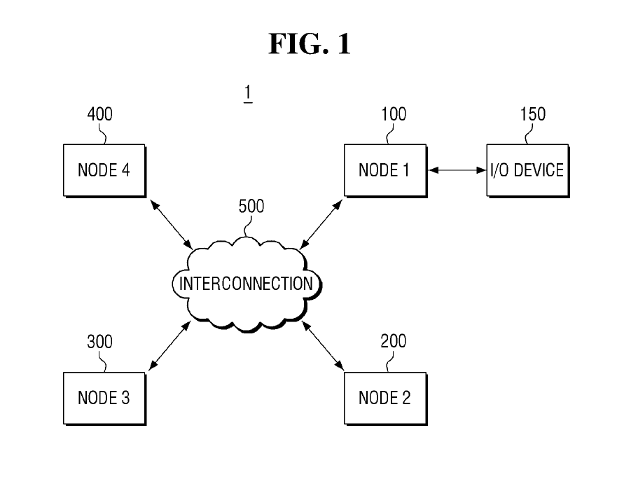

FIG. 1 is a diagram schematically illustrating an operating environment for a semiconductor system according to an exemplary embodiment of the present disclosure.

Referring to FIG. 1, an operating environment 1 for a semiconductor system according to an exemplary embodiment of the present disclosure may include a plurality of nodes 100, 200, 300 and 400, and an interconnection 500 for connecting the plurality of nodes 100, 200, 300 and 400 to one another. Although only four nodes are shown in FIG. 1, the number of the nodes is not limited to four.

Each of the nodes 100, 200, 300 and 400 may include one or more processing units. The one or more processing units in each of the nodes 100, 200, 300 and 400 may be grouped into a cluster. The number of processing units grouped into a cluster may differ from node to node depending on the system implemented.

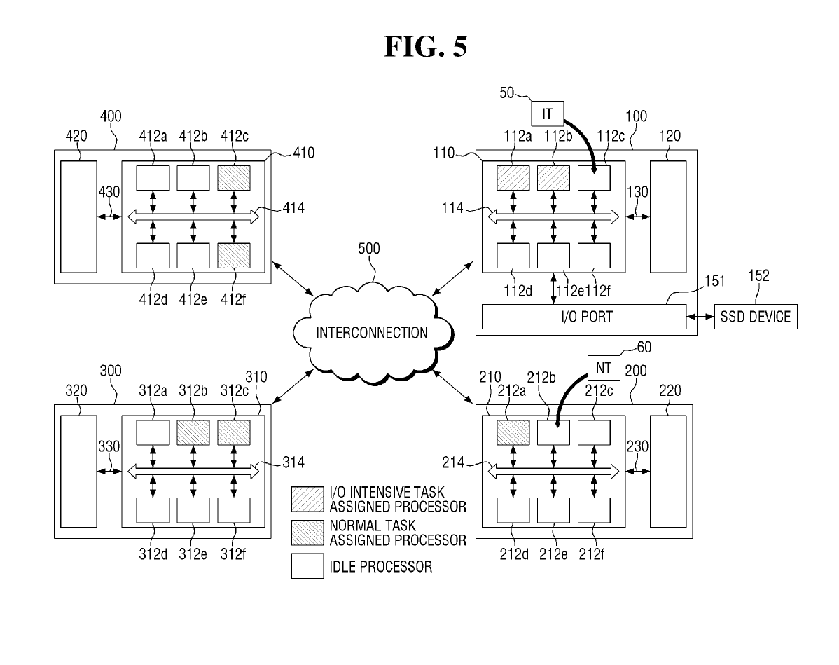

Each of the nodes 100, 200, 300 and 400 may include a cluster having one or more processing units and a memory directly connected to the cluster. In addition, some of the nodes, i.e., the node 100 may include an I/O port for transmitting/receiving data to/from an I/O device 150. A configuration of each of the nodes 100, 200, 300 and 400 will be described in detail with reference to FIG. 5.

In various exemplary embodiments of the present disclosure, the operating environment 1 may be a non-uniform memory access (NUMA) architecture. Accordingly, the processing units in each of the nodes 100, 200, 300 and 400 may access the memory directly connected to the respective nodes or may access the memory directly connected to another node. For example, the processing units included in the node 100 may access the memory directly connected to the node 100, (i.e., a local memory) or may access the memory directly connected to the node 200 (i.e., a remote memory). It will be appreciated that there is a time difference between when the processing units included in the node 100 accesses the local memory and when it accesses the remote memory.

It is to be pointed out that the processing units included in each of the nodes 100, 200, 300 and 400 may access an I/O device directly connected to the respective nodes or may access an I/O device directly connected to another node, similarly to the access to the memories. For example, the processing units included in the node 100 may access an I/O device 150 directly connected to the node 100 (i.e., a local I/O device), and the processing units included in the node 200 may access an I/O device 150 directly connected to the node 100 (i.e., a remote I/O device). In doing so, there is a time difference between when the processing units included in the node 100 process a task accessing the local I/O device 150 and when the processing units included in the node 200 process a task accessing the remote I/O device 150.

In the following description, when a processor accesses a local memory, a local I/O device or the like directly connected to the node to which the processor belongs, the node is referred to as a local node. On the other hand, when a processor accesses a remote memory, a remote I/O device or the like that is directly connected to another node, the node is referred to as a remote node.

As used herein, if a task or a substantial portion of a task accesses an I/O device, the task is referred to as an I/O intensive task, otherwise the task is referred to as to a normal task.

In some exemplary embodiments of the present disclosure, an I/O device may include a storage device. For example, the storage device may include a solid state drive (SSD) and/or a hard disk drive (HDD). However, the storage unit is not limited to those mentioned above, but may include any device or system that performs an I/O task.

The interconnection 500 may be a bus or a switch connecting between the plurality of nodes 100, 200, 300 and 400. The topology is not limited to a particular form but may be formed as desired.

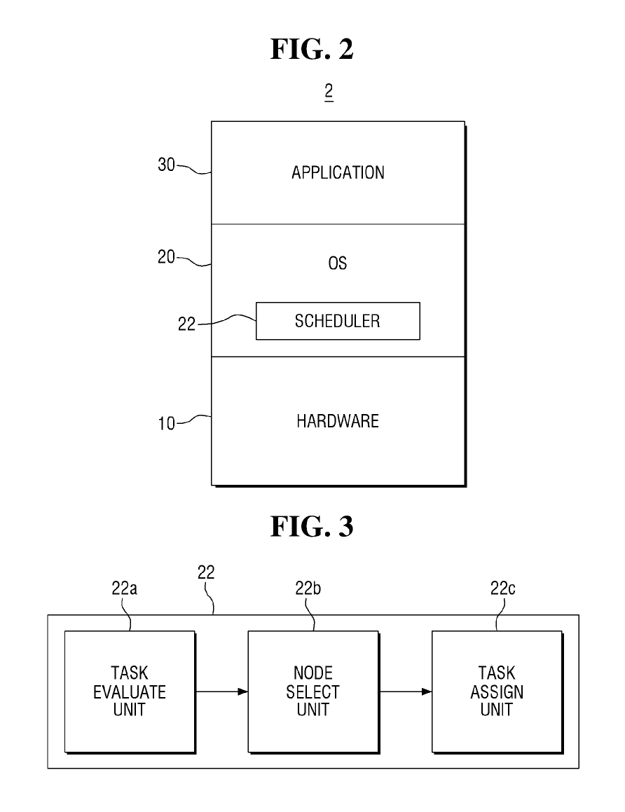

FIG. 2 is a diagram schematically illustrating an environment in which a semiconductor system according to an exemplary embodiment of the present disclosure may be implemented.

Referring to FIG. 2, an environment 2 in which a semiconductor system, according to an exemplary embodiment of the present disclosure, may be implemented may include hardware 10, an operating system 20 and an application 30.

The operating system 20 manages overall operation of a computer system 1 including controlling the hardware 10 and supporting execution of the application 30, for example. For example, the operating system 20 may receive a request from the application 30, arrange a series of tasks for processing the request, and assign these tasks to the hardware 20. In addition, the operating system 20 may deliver the series of tasks processed by the hardware 10 to the application 30.

In some embodiments of the present disclosure, the operating system 20 may be, but is not limited to, MacOS® provided by Apple Inc., Windows® provided by Microsoft corporation, UNIX®, Linux®, etc., or a mobile operating system such as iOS provided by Apple Inc., Android™ provided by Google Inc, etc.

In some embodiments of the present disclosure, the hardware 10 may include, but is not limited to, processing units such as at least one central processing unit (CPU), graphic processing unit (GPU), application processor (AP), cellular processor (CP) and digital signal processor (DSP); a memory such as a read only memory (ROM) and a random access memory (RAM); a storage device such as hard Disk Drive (HDD) and solid state drive (SSD); and other peripherals. In particular, in some embodiments of the present disclosure, the hardware 10 may include a multiprocessor or a multiprocessing unit.

Referring to FIG. 2, the application 30 may receive requests including a data input/output task from a user. The operating system 20 may generate and execute tasks for processing the requests. In particular, the operating system 20 may include a scheduler 22 that assigns the generated tasks to the hardware 10 appropriately. The method for operating a semiconductor device according to various exemplary embodiments of the present disclosure may be implemented as software as a part of the operating system 20, such as the scheduler 22. However, this is merely illustrative and the method may be implemented as a circuit such as an application specific integrated circuit (ASIC) and a field programmable gate array (FPGA), or a circuit of a system-on-chip (SoC).

FIG. 3 is a block diagram schematically illustrating the scheduler of FIG. 2 in greater detail, according to an exemplary embodiment of the present disclosure.

Referring to FIG. 3, a scheduler 22 according to an exemplary embodiment of the present disclosure includes a task evaluating unit 22a, a node selecting unit 22b, and a task assigning unit 22c.

The task evaluating unit 22a obtains information on tasks processed in a multiprocessor system, i.e., task structure information. In addition, the task evaluating unit 22a evaluates the task structure information to determine if the task is an I/O intensive task.

In some embodiments of the present disclosure, the task structure information may include task_struct structure. For example, the internal configuration of task_struct structure may typically include a variety of information items such as information for identifying a task (e.g., variable pid), information on a user access right (e.g., variable uid), information on the state of a task (e.g., execute state, interruptible state, uninterruptible state, interrupted state), information on the relationship between tasks (e.g., information on parent/child), information on scheduling (e.g., scheduling policy), information on a signal provided to a task, information on a file accessed by a task, information on an implementation of context switching, etc., although the configuration may vary depending on the system implemented. The task evaluating unit 22a may determine if the task is an I/O intensive task based on the above-mentioned information.

In some embodiments of the present disclosure, the task evaluating unit 22a may also obtain a list of the plurality of nodes 100, 200, 300 and 400 included in the multiprocessor system. The list of the plurality of nodes 100, 200, 300 and 400 is not limited to a particular data structure but may be implemented as any of a variety of data structures.

The node selecting unit 22b selects a node to which a task is assigned, i.e., a target node depending on whether the task is an I/O intensive task.

Specifically, if it is determined that the task is an I/O intensive task, the node selecting unit 22b may select, as the target node, a local node to which an I/O device is directly connected. On the other hand, if it is determined that the task is not an I/O intensive task, the node selecting unit 22b may select, as the target node, a remote node to which an I/O device is not directly connected. In some other embodiments of the present disclosure, if it is determined that the task is not an I/O intensive task, the node selecting unit 22b may select, as the target node, a node including an idle processing unit (an idle node), irrespective of whether an I/O device is not directly connected thereto.

In some embodiments of the present disclosure, the node selecting unit 22b may search the list of the plurality of nodes 100, 200, 300 and 400. For example, the node selecting unit 22b may search the list of the plurality of nodes 100, 200, 300 and 400 while selecting a local node or a remote node as the target node.

The task assigning unit 22c assigns the task to the target node selected by the node selecting unit 22b. Then, one or more processing units included in the target node process the task.

As such, the scheduler 22 according to the exemplary embodiment of the present disclosure determines whether a task is an I/O intensive task and assigns the I/O intensive task to a local node. Accordingly, it is possible to save time taken to process a task accessing an I/O device, such that I/O intensive tasks can be processed quickly.

In particular, the scheduler 22 according to the exemplary embodiment of the present disclosure evaluates only the task structure information at the level of the operating system 20 (or kernel) to determine whether a task is an I/O intensive task or not, rather than evaluating the history as in the related art, to save time taken to process a task accessing an I/O device. Accordingly, it is possible to determine in which node a task is to be processed without maintaining additional history information on even a new task, such that it is not necessary to maintain additional information such as history information.

Hereinafter, examples of the method for operating a semiconductor device according to various exemplary embodiments of the present disclosure will be described.

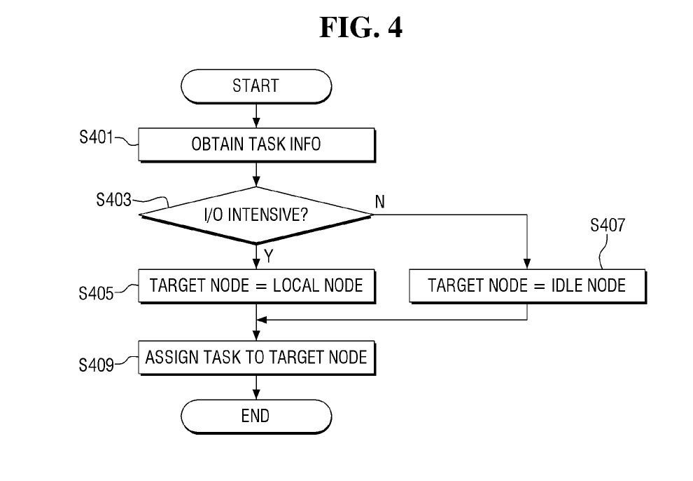

FIG. 4 is a flowchart for illustrating a method for operating a semiconductor device according to an exemplary embodiment of the present disclosure.

Referring to FIG. 4, the method for operating a semiconductor device according to an exemplary embodiment of the present disclosure includes obtaining task structure information on tasks processed in the multiprocessor system (step S401). As described above, the task structure information may include task_struct structure.

Subsequently, the method includes evaluating the task structure information to determine whether the task is an I/O intensive task (step S403). If it is determined that the task is an I/O intensive task (Yes in step S403), the method includes selecting a local node as a target node to which the task is assigned (step S405).

On the other hand, if it is determined that the task is not an I/O intensive task (No in step S403), the method includes selecting an idle node as the target node to which the task is assigned (step S407). As used herein, the idle node refers to a node including an idle processing unit, irrespective of whether or not an I/O device is directly connected thereto.

Subsequently, the method includes assigning the task to the target node that is selected based on the determination as to whether the task is an I/O intensive task (step S409).

FIG. 5 is a diagram for schematically illustrating a method for operating a semiconductor device according to an exemplary embodiment of the present disclosure.

Referring to FIG. 5, the nodes 100, 200, 300 and 400 include clusters 110, 210, 310 and 410 each including one or more processing units, and memories 120, 220, 320, 420 directly connected to the clusters 110, 210, 310 and 410, respectively. In addition, the nodes 100, 200, 300 and 400 may be connected to one another via the interconnection 500.

For example, the node 100 may include a cluster 110 including processing units 112a to 112f, and the processing units 112a to 112f may be connected to one another via a processing unit bus 114. Although not shown in FIG. 5, the cluster 110 may further include cache memories assigned to the processing units 112a to 112f, respectively. The cluster 110 is connected to a memory 120 via a bus 130. Although a cluster includes six processing units in this exemplary embodiment, this is merely illustrative. The number of processing units in a cluster may vary depending on the system implemented. The nodes 200, 300 and 400 may also have a similar configuration to that of the node 100.

More specifically, the node 200 may include a cluster 210 including processing units 212a to 212f, and the processing units 212a to 212f may be connected to one another via a processing unit bus 214. The cluster 210 is connected to a memory 220 via a bus 230. The node 300 may include a cluster 310 including processing units 312a to 312f, and the processing units 312a to 312f may be connected to one another via a processing unit bus 314. The cluster 310 is connected to a memory 320 via a bus 330. And the node 400 may include a cluster 410 including processing units 412a to 412f, and the processing units 412a to 412f may be connected to one another via a processing unit bus 414. The cluster 410 is connected to a memory 420 via a bus 430.

However, it is to be noted that the node 100 has an I/O port 151 for direct connection to an I/O device, i.e., an SSD 152, unlike the other nodes 200, 300 and 400. In some embodiments of the present disclosure, the I/O port 151 may support an interface including, but not limited to, PCI Express (PCIe), serial AT attachment (SATA), universal serial bus (USB), etc.

Accordingly, when an I/O intensive task is processed, the node 100 that is directly connected to the SSD 152 becomes a local node, whereas the nodes 200, 300 and 400 that are not directly connected to the SSD 152 become remote nodes. Hereinafter, a variety of examples will be described under the above assumptions.

Referring to FIG. 5, in the node 100, the processing units 112a and 112b are assigned I/O intensive tasks, and the processing units 112c to 112f are in the idle state. In addition, a processing unit 212a in the node 200, the processing units 312b and 312c in the node 300 and the processing units 412c and 412f in the node 400 are assigned normal tasks.

As described above with reference to FIG. 4, if it is determined that a task 50 is an I/O intensive task (IT), the task 50 is assigned to the local node, i.e., the node 100. Specifically, the task 50 may be assigned to the idle processing unit 112c in the node 100.

On the other hand, if it is determined that a task 60 is not an I/O intensive task (NT), the task 60 is assigned to the idle node, e.g., the node 200. Specifically, the task 60 may be assigned to the idle processing unit 212b in the node 200.

According to the method for operating a semiconductor device according to the exemplary embodiment of the present disclosure, it is possible to quickly determine whether a task is an I/O intensive task or not, without maintaining additional history information, and then process the task determined as an I/O intensive task in the local node. As a result, I/O intensive tasks can be quickly processed.

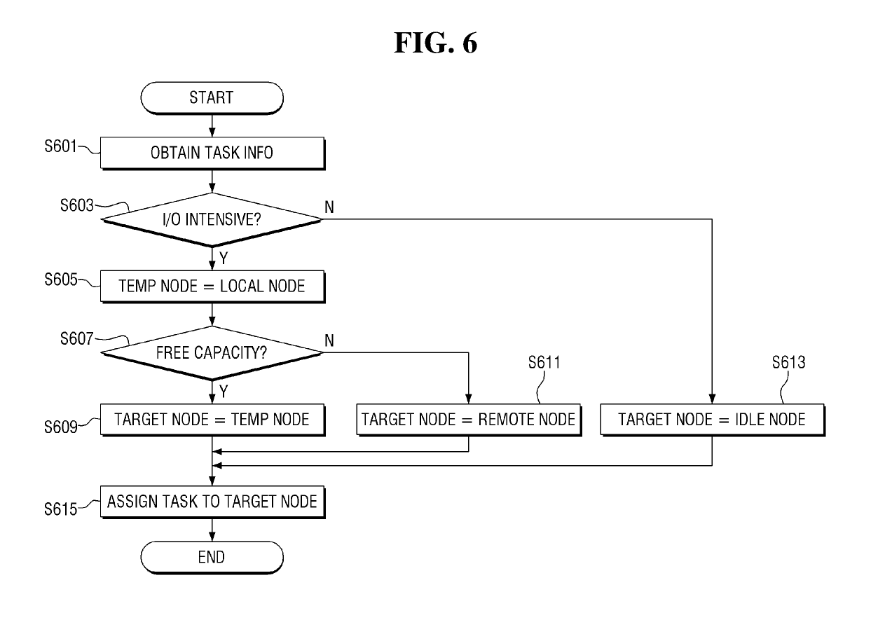

FIG. 6 is a flowchart for illustrating a method for operating a semiconductor device according to another exemplary embodiment of the present disclosure.

Referring to FIG. 6, the method for operating a semiconductor device according to another exemplary embodiment of the present disclosure includes obtaining task structure information on tasks processed in the multiprocessor system (step S601). As described above, the task structure information may include task_struct structure.

Subsequently, the method includes evaluating the task structure information and determining whether the task is an I/O intensive task (step S603). If it is determined that the task is an I/O intensive task (Yes in step S603), the method includes selecting a local node as a temporary node (step S605).

Subsequently, the method includes determining whether the local node selected as the temporary node includes an idle processing unit (step S607). If it is determined that the local node selected as the temporary node includes an idle processing unit (Yes in step S607), the method includes designating the temporary node as a target node to which the task is assigned (step S609). As a result, the local node is selected as the target node.

On the other hand, if it is determined that the local node selected as the temporary node does not include an idle processing unit (No in step S607), the method includes selecting a remote node as the target node to which the task is assigned (step S611).

In addition, if it is determined that the task is not an I/O intensive task (No in step S603), the method includes selecting an idle node as the target node to which the task is assigned (step S613). As described above, the idle node refers to a node including an idle processing unit, irrespective of whether or not an I/O device is directly connected thereto.

Subsequently, the method includes assigning the task to the target node that is selected based on the determination as to whether the task is an I/O intensive task (step S615).

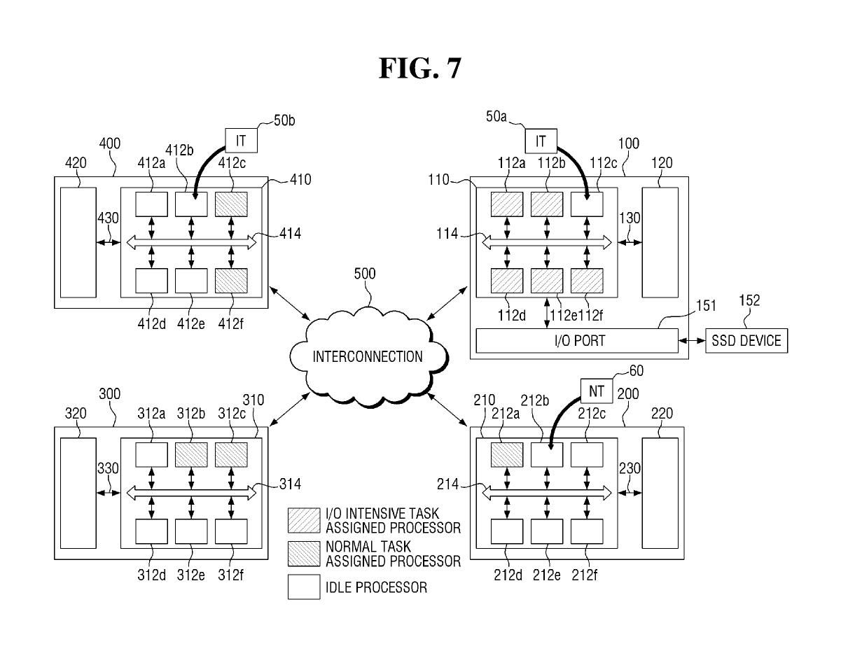

FIG. 7 is a diagram schematically illustrating a method for operating a semiconductor device according to another exemplary embodiment of the present disclosure.

Referring to FIG. 7, in node 100, the processing units 112a, 112b, 112d, 112e and 112f are assigned I/O intensive tasks, and the processing unit 112c is in the idle state. In addition, a processing unit 212a in the node 200, the processing units 312b and 312c in the node 300 and the processing units 412c and 412f in the node 400 are assigned normal tasks.

As described above with reference to FIG. 6, if it is determined that a task 50a is an I/O intensive task, the task 50a is assigned to the local node, i.e., the node 100. Specifically, the task 50 may be assigned to the idle processing unit 112c in the node 100.

Then, if it is determined that a task 50b is also an I/O intensive task, the task 50b is supposed to be assigned to the local node, i.e., the node 100, but the node 100 does not include an idle processing unit any more. When this happens, the task 50b is assigned to a remote node, e.g., the node 400, rather than waiting for being processed by the node 100. Specifically, the task 50b may be assigned to the idle processing unit 412b in the node 400.

On the other hand, if it is determined that a task 60 is not an I/O intensive task, the task 60 is assigned to an idle node, e.g., the node 200. Specifically, the task 60 may be assigned to the idle processing unit 212b in the node 200.

According to the method for operating a semiconductor device according to the exemplary embodiment of the present disclosure, it is possible to quickly determine whether a task is an I/O intensive task or not, without maintaining additional history information, and then process the task determined as an I/O intensive task in the local node. As a result, I/O intensive tasks can be quickly processed. Further, if there is no idle processing unit in the local node, the I/O intensive task is processed in a remote node, instead of waiting for an idle processing unit in the local node. As a result, I/O intensive tasks can be quickly processed.

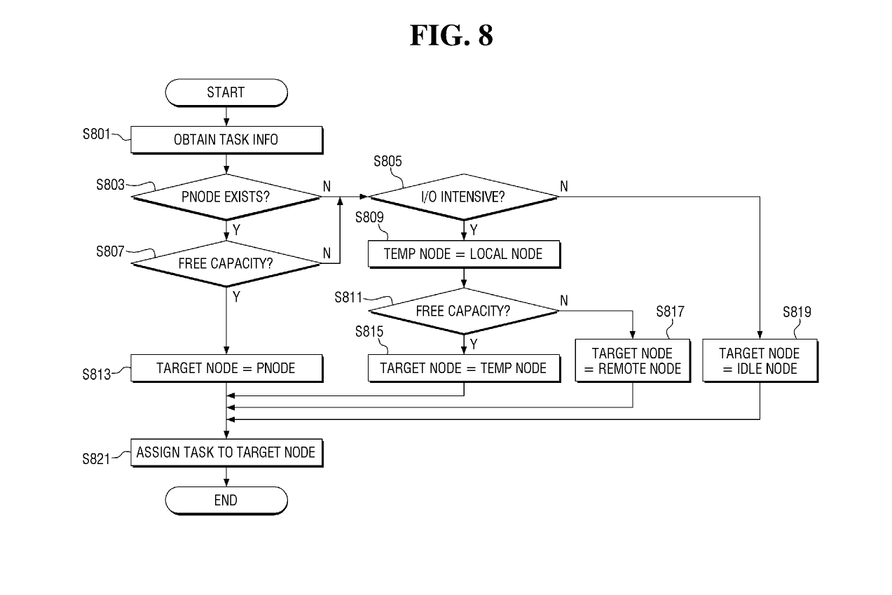

FIG. 8 is a flowchart for illustrating a method for operating a semiconductor device according to yet another exemplary embodiment of the present disclosure.

Referring to FIG. 8, the method for operating a semiconductor device according to yet another exemplary embodiment of the present disclosure includes obtaining task structure information on tasks processed in the multiprocessor system (step S801). As described above, the task structure information may include task_struct structure.

Subsequently, it is determined whether the task structure information contains preferred node information (PNODE) on the task (step S803). In some embodiments of the present disclosure, the preferred node information may be contained in the task_struct structure.

In some embodiments of the present disclosure, the preferred node information may be created based on the history of one of a plurality of nodes in the multi-processing system to which the task has been assigned. Specifically, if there is a history of a node to which a task has been assigned, the task may be assigned to the node initially when the task has to be rescheduled in the multiprocessor system.

In some embodiments of the present disclosure, the preferred node information may be input or altered via the operating system 20 running on the multiprocessor system. That is, it is possible to assign the task to a particular node initially via the operating system 20, pursuant to the intention of a manager or a user, for example, if desired.

If the preferred node information on the task is contained in the task structure information (Yes in step S803), the method includes determining whether there is an idle processing unit in the preferred node (step S807). If it is determined that there is an idle processing unit in the preferred nodes (Yes in step S807), the method includes selecting the preferred node as the target node to which the task is assigned (step S813).

On the other hand, if the task structure information does not contain the preferred node information on the task (No in step S803) or if the task structure information contains the preferred node information on the task but there is no idle processing unit in the preferred nodes (No in step S807), the task structure information is further evaluated to determine whether the task is an I/O intensive task (step 805). If it is determined that the task is an I/O intensive task (Yes in step S805), the method includes selecting a local node as a temporary node (step S809).

Subsequently, the method includes determining whether the local node selected as the temporary node includes an idle processing unit (step S811). If it is determined that the local node selected as the temporary node includes an idle processing unit (Yes in step S811), the method includes designating the temporary node as the target node to which the task is assigned (step S815). As a result, the local node is selected as the target node.

On the other hand, if it is determined that the local node selected as the temporary node does not include an idle processing unit (No in step S811), the method includes selecting a remote node as the target node to which the task is assigned (step S817).

In addition, if it is determined that the task is not an I/O intensive task (No in step S805), the method includes selecting an idle node as the target node to which the task is assigned (step S819). As described above, the idle node refers to a node including an idle processing unit, irrespective of whether or not an I/O device is directly connected thereto.

Subsequently, the method includes assigning the task to the target node that is selected based on the determination as to whether the task is an I/O intensive task (step S821).

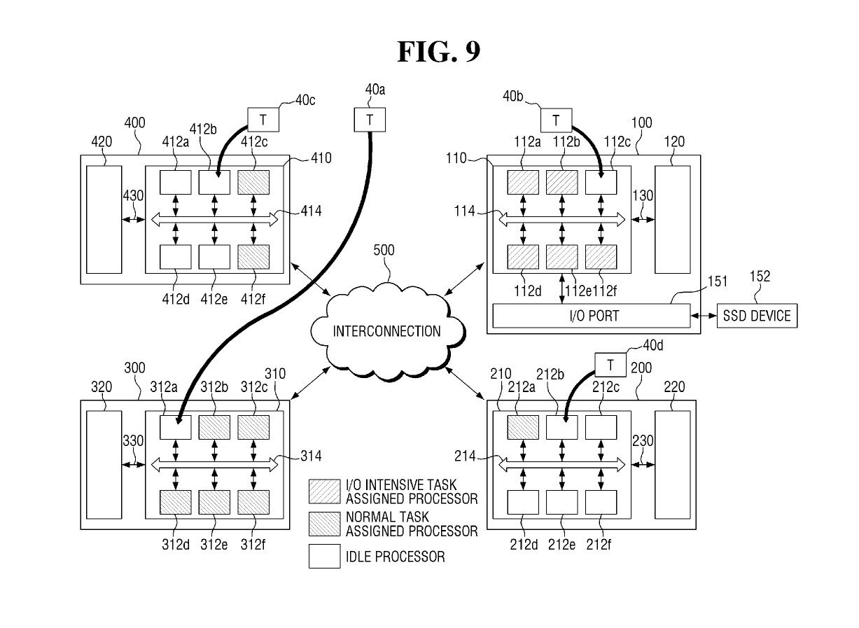

FIG. 9 is a diagram schematically illustrating a method for operating a semiconductor device according to still another exemplary embodiment of the present disclosure.

Referring to FIG. 9, in node 100, the processing units 112a, 112b, 112d, 112e and 112f are assigned I/O intensive tasks, and the processing unit 112c is in the idle state. In addition, a processing unit 212a in the node 200, the processing units 312b and 312d to 312f in the node 300 and the processing units 412c and 412f in the node 400 are assigned normal tasks.

As described above with reference to FIG. 8, if it is determined that the task structure information on a task 40a indicates a node 300 as a preferred node, the task 40a is assigned to the preferred node, i.e., the node 300. Specifically, the task 40a may be assigned to an idle processing unit 312a in the node 300.

Then, if it is determined that the task structure information on a task 40b also indicates the node 300 as a preferred node, the task 40b is supposed to be assigned to the preferred node, i.e., the node 300, but the node 300 does not include an idle processing unit any more.

When this happens, the task structure information on the task 40b is further evaluated to determine whether the task 40b is an I/O intensive task, and, if so, the task 40b is assigned to the local node, i.e., the node 100. Specifically, the task 40b may be assigned to the idle processing unit 112c in the node 100.

Then, if it is determined that the task structure information on a task 40c also indicates the node 300 as a preferred node, the task 40c is supposed to be assigned to the preferred node, i.e., the node 300, but the node 300 does not include an idle processing unit any more.

When this happens, the task structure information on the task 40c is further evaluated to determine whether the task 40c is an I/O intensive task, and, if so, the task 40c is assigned to the local node, i.e., the node 100. However, the node 100 does not include an idle processing unit.

At this time, the task 40c is assigned to a remote node, e.g., the node 400, rather than waiting for being processed by the node 100. Specifically, the task 40c may be assigned to the idle processing unit 412b in the node 400.

On the other hand, for a task 40d, if it is determined that neither the task structure information contains the preferred node information on the task 40d nor the task 40d is an I/O intensive task, the task 40d is assigned to an idle node, e.g., the node 200. Specifically, the task 40d may be assigned to the idle processing unit 212b in the node 200.

According to the method for operating a semiconductor device according to the exemplary embodiment of the present disclosure, it is possible to quickly determine whether a task is an I/O intensive task or not, without maintaining additional history information, and then process the task determined as an I/O intensive task in the local node. As a result, I/O intensive tasks can be quickly processed. In addition, a task can be assigned to a particular node initially, so that ways of processing tasks in the multiprocessing system can be diversified.

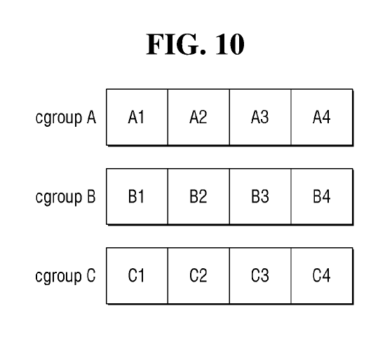

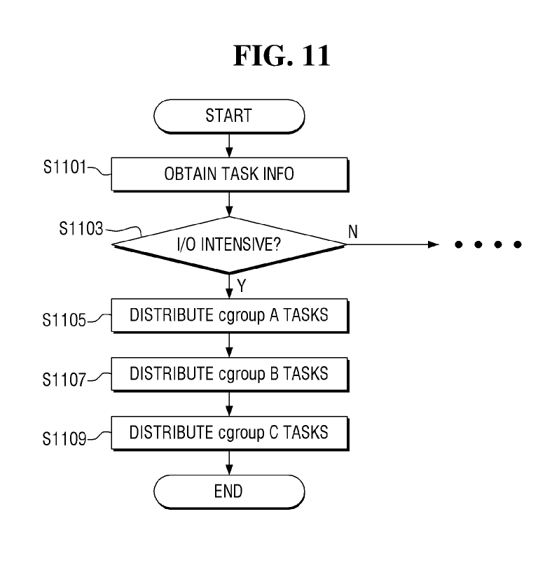

FIG. 10 is a diagram schematically illustrating a method for operating a semiconductor device according to yet another exemplary embodiment of the present disclosure. FIG. 11 is a flowchart for illustrating a method for operating a semiconductor device according to yet another exemplary embodiment of the present disclosure.

Referring to FIG. 10, control groups may be supported on the operating system 20, in which a first control group, cgroup A, may include I/O intensive tasks A1 to A4, a second control group, cgroup B, may include I/O intensive tasks B1 to B4, and a third control group, cgroup C, may include I/O intensive tasks C1 to C4.

Referring to FIG. 11, a method for operating a semiconductor device according to yet another exemplary embodiment of the present disclosure includes obtaining task structure information on tasks processed in the multiprocessor system (step S1101). As described above, the task structure information may include task_struct structure.

Subsequently, the method includes evaluating the task structure information and determining whether each of the task is an I/O intensive task (step S1103). In this example, the tasks correspond to those shown in FIG. 10 and it is assumed they are all I/O intensive tasks (Yes in step S1103).

Subsequently, the tasks A1 to A4 included in the first control group, cgroup A, are distributed to local and remote nodes (step S1105), the tasks B1 to B4 included in the second control group, cgroup B, are distributed to local and remote nodes (step S1107), and the tasks C1 to C4 included in the third control group, cgroup C, are distributed to local and remote nodes (step S1109).

Specifically, some of tasks included in each of the first control group, cgroup A, to third control group, cgroup C, are assigned to a local node, and others to remote nodes.

In some embodiments of the present disclosure, the number of tasks of each of the first control group, cgroup A, to third control group, cgroup C, distributed to the local node may be equal to one another.

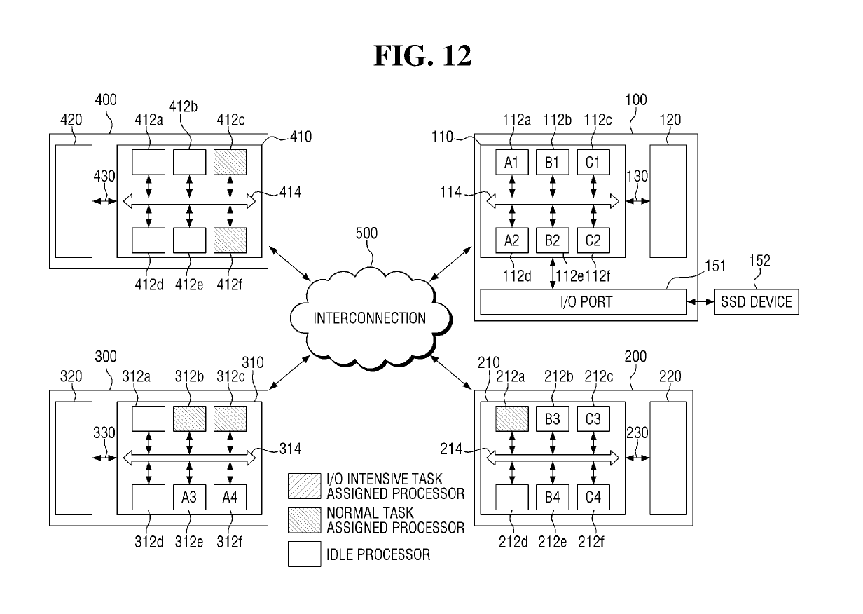

FIG. 12 is a diagram schematically illustrating a method for operating a semiconductor device according to still another exemplary embodiment of the present disclosure.

Referring to FIG. 12, a processing unit 212a in the node 200, the processing units 312b and 312c in the node 300 and the processing units 412c and 412f in the node 400 are assigned normal tasks.

As described above with reference to FIG. 11, some of the tasks included in the first control group, cgroup A, i.e., A1 and A2 are assigned to the local node, i.e., the node 100. Specifically, the tasks A1 and A2 may be assigned to the processing units 112a and 112d in the node 100. In addition, others of the tasks included in the first control group, cgroup A, i.e., A3 and A4 may be assigned to the node 300.

Some of the tasks included in the second control group, cgroup B, i.e., B1 and B2 are also assigned to the local node, i.e., the node 100. Specifically, the tasks B1 and B2 may be assigned to the processing units 112b and 112e in the node 100. In addition, others of the tasks included in the second control group, cgroup B, i.e., B3 and B4 may be assigned to the node 200.

Some of the tasks included in the third control group, cgroup C, i.e., C1 and C2 are also assigned to the local node, i.e., the node 100. Specifically, the tasks C1 and C2 may be assigned to the processing units 112c and 112f in the node 100. In addition, others of the tasks included in the third control group cgroup C, i.e., C3 and C4 may be assigned to the node 200.

According to the method for operating a semiconductor device according to the exemplary embodiment of the present disclosure, it is possible to quickly determine whether a task is an I/O intensive task or not, without maintaining additional history information, and then process the task determined as an I/O intensive task in the local node. As a result, I/O intensive tasks can be quickly processed. In addition, when a large number of I/O intensive tasks have to be processed in a short period of time, it is useful to use the control group scheme to uniformly process them.

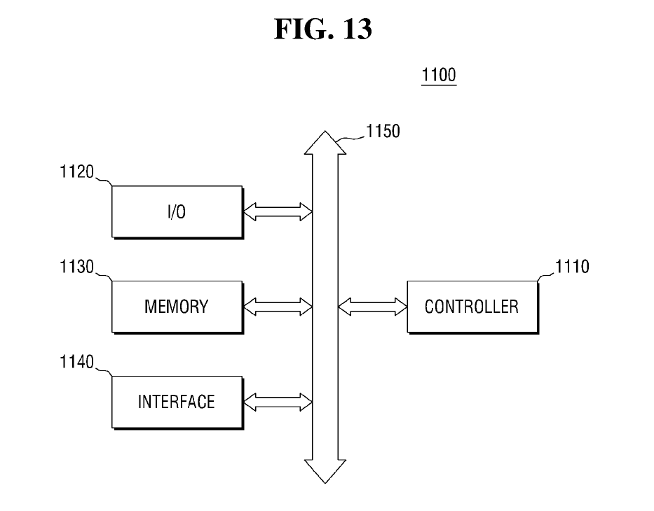

FIG. 13 is a block diagram of an electronic system that can employ the method of operating a semiconductor device and a semiconductor system according to any of the exemplary embodiments of the present disclosure.

Referring to FIG. 13, the electronic system 1100 according to an exemplary embodiment of the present disclosure may include a controller 1110, an I/O (input/output) device 1120, a memory device 1130, an interface 1140, and a bus 1150. The controller 1110, the I/O device 1120, the memory device 1130 and/or the interface 1140 may be connected to one another via the bus 1150. The bus 1150 may serve as a path via which data is transferred.

The controller 1110 may include at least one of a microprocessor, a digital signal processor, a microcontroller and logic elements capable of performing similar functions. The I/O device 1120 may include a keypad, a keyboard, a display device, etc. The memory device 1130 may store therein data and/or instructions, for example. The interface 1140 may be capable of transmitting/receiving data to/from a communication network. The interface 1140 may be either a wired or wireless interface. For example, the interface 1140 may include an antenna, a wired/wireless transceiver or the like.

Although not shown in FIG. 13, the electronic system 1100 may include an operational memory for improving the operation of the controller 1100 and may further include a high-speed DRAM and/or SRAM, for example.

Additionally, the processor according to any of the exemplary embodiments of the present disclosure may be provided in the memory device 1130 or may be provided as a part of the controller 1110, the I/O device 1120, etc.

The semiconductor system 1100 may be applied to a PDA (personal digital assistant), a portable computer, a web tablet, a wireless phone, a mobile phone, a digital music player, a memory card, or any electronic device capable of transmitting/receiving information in wireless environment.

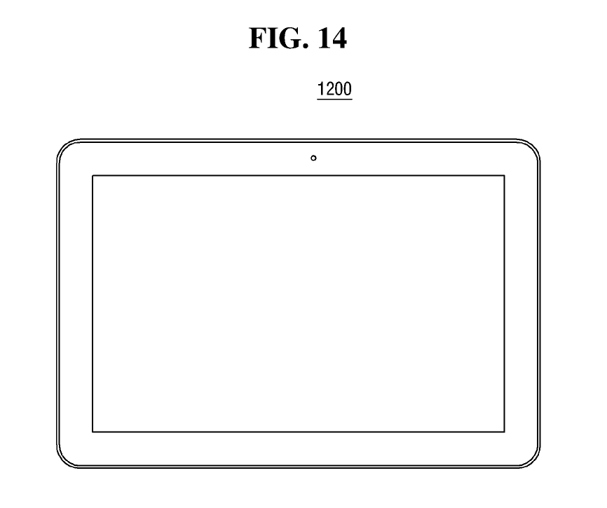

FIGS. 14 to 16 show examples of semiconductor systems that can employ the method of operating a semiconductor device according to some exemplary embodiments of the present disclosure.

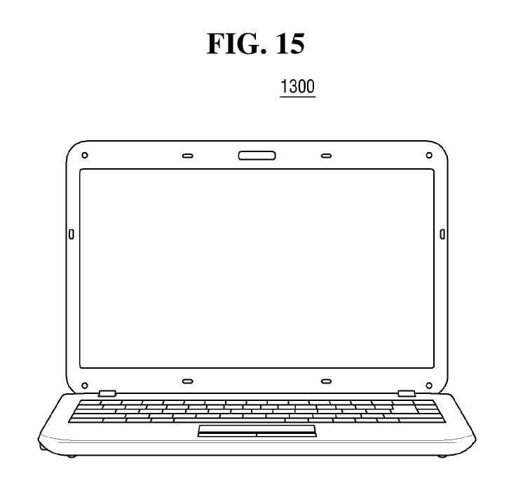

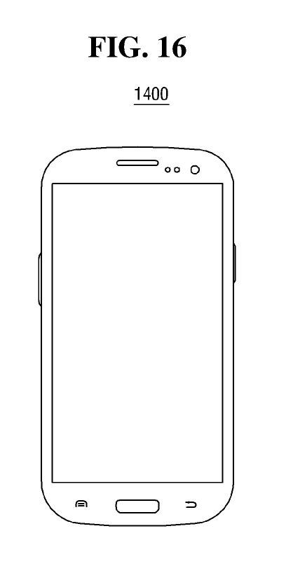

FIG. 14 shows a tablet PC 1200, FIG. 15 shows a laptop computer 1300, and FIG. 16 shows a smartphone 1400. At least one of the processors according to the exemplary embodiments of the present disclosure may be employed by the tablet PC 1200, the laptop computer 1300, the smartphone 1400, etc.

As will be appreciated by those skilled in the art, the semiconductor devices fabricated according to some exemplary embodiments of the present disclosure may be employed by other integrated circuit devices than those mentioned above.

Namely, in the foregoing descriptions, the tablet PC 1200, the laptop computer 1300 and the smartphone 1400 have been mentioned as examples of the semiconductor system according to this exemplary embodiment, the examples of the semiconductor system are not limited thereto.

In some exemplary embodiments of the present disclosure, the semiconductor system may be implemented as: a computer, a UMPC (Ultra Mobile PC), a workstation, a net-book, a PDA (Personal Digital Assistants), a portable computer, a wireless phone, a mobile phone, an e-book, a PMP (portable multimedia player), a portable game console, a navigation device, a black box, a digital camera, a 3-dimensional television, a digital audio recorder, a digital audio player, a digital picture recorder, a digital picture player, a digital video recorder, a digital video player, etc.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Although preferred embodiments of the present disclosure have been described for illustrative purposes, those skilled in the art will appreciate that various modifications, additions and substitutions are possible, without departing from the scope and spirit of the disclosure as disclosed in the accompanying claims.

1. A method, executed by an electronic device, for operating a semiconductor device, the method comprising:
obtaining task structure information of a task processed in a multiprocessor system, wherein the multiprocessor system comprises a plurality of nodes, each of the nodes comprising one or more processing units and a memory directly connected to the one or more processing units, the plurality of nodes comprising a local node to which an input/output (I/O) device is directly connected and a remote node having no direct connection to the I/O device;
evaluating the task structure information to determine whether the task is an I/O intensive task or not; and
assigning the task to the local node or remote node, wherein the task is preferentially assigned to the local node if the task is evaluated to be the I/O intensive task.

2. The method of claim 1, wherein the task is preferentially assigned to the remote node if the task is evaluated to not be the I/O intensive task.

3. The method of claim 1, further comprising assigning the task to an idle one of the one or more processing units of the remote node if the task is evaluated to not be the I/O intensive task.

4. The method of claim 1, wherein the task structure information comprises task_struct structure.

5. The method of claim 1, wherein the I/O intensive task comprises a task accessing the I/O device.

6. The method of claim 1, wherein the multiprocessor system is implemented as a non-uniform memory access (NUMA) architecture.

7. The method of claim 1, wherein the I/O device comprises a storage device.

8. The method of claim 7, wherein the storage device comprises a solid state drive (SSD) or a hard disk drive (HDD).

9. The method of claim 1, wherein preferentially assigning the I/O intensive task to the local node further comprises:
determining whether there is an idle processing unit among the one or more processing units of the local node; and
assigning the task to the remote node if there is no idle processing unit determined to be in the local node.

10. The method of claim 1, further comprising:
determining whether the task structure information contains preferred node information of the task; and
assigning the task to one of the plurality of nodes, which the preferred node information indicates as being a preferred node, if the task structure information is determined to contain the preferred node information.

11. The method of claim 10, wherein the assigning the task to the preferred node comprises:
determining whether there is an idle processing unit among the one or more processing units of the preferred node; and
further evaluating the task structure information if there is no idle processing unit determined to be in the preferred node.

12. The method of claim 10, wherein the preferred node information is created based on a history of a particular one of the plurality of nodes to which the task has been assigned.

13. The method of claim 10, wherein the preferred node information is input or altered via an operating system running on the multiprocessor system.

14. The method of claim 1, further comprising:
processing a plurality of tasks in the multiprocessor system, the plurality of tasks comprising tasks included in a first control group and tasks included in a second control group different from the first control group, and
distributing the tasks included in each of the first and second control groups among the local node and the remote node.

15. The method of claim 14, wherein the distributing the tasks comprises:
assigning some of the tasks included in each of the first and second control groups to the local node; and
assigning others of the tasks included in each of the first and second control groups to the remote node.

16. The method of claim 14, wherein the distributing the tasks comprises distributing the tasks in each of the first and second control groups such that the number of tasks of each of the first and second control groups distributed to the local node is equal to each other.

17. A method, executed by an electronic device, for operating a semiconductor device, the method comprising:
obtaining a list of a plurality of tasks processed in a multiprocessor system;
obtaining a list of a plurality of nodes included in the multiprocessor system;
sorting the plurality of tasks into input/output (I/O) intensive tasks and normal tasks; and
assigning the I/O intensive tasks, wherein:
the I/O intensive tasks are preferentially assigned to a local node to which an I/O device is directly connected, and
the normal tasks are preferentially assigned to a remote node having no direct connection to the I/O device.

18. The method of claim 17, wherein the assigning the I/O intensive tasks preferentially to the local node comprises:
determining whether there is an idle processing unit among one or more processing units of the local node; and
assigning the I/O intensive tasks to the remote node if there is no idle processing unit determined to be in the local node.

19. The method of claim 17, wherein:
the I/O intensive tasks comprise I/O intensive tasks included in a first control group and I/O intensive tasks included in a second control group different from the first control group, and
the assigning the I/O intensive tasks preferentially to the local node comprises distributing an I/O intensive task from each of the first and second control groups to the local node.

20-22. (canceled)

23. A semiconductor device comprising:
a memory comprising computer-readable instructions; and
at least one processor configured to execute the computer-readable instructions, wherein the computer-readable instructions cause the processor to perform a method comprising:
obtaining task structure information of a task processed in a multiprocessor system, wherein the multiprocessor system comprises a plurality of nodes each comprising one or more processing units and a memory directly connected to the one or more processing units, the plurality of nodes comprising a local node to which an input/output (I/O) device is directly connected and a remote node having no direct connection to the I/O device;
evaluating the task structure information to determine whether the task is an I/O intensive task or not; and
assigning the task to the local node if the task is evaluated to be the I/O intensive task.

24-42. (canceled)
